(19) United States
(12) Patent Application Publication
(10) Pub. No.: US 2024/0265330 A1
(43) Pub. Date: Aug. 8, 2024

(54) MANAGEMENT DEVICE, MANAGEMENT METHOD, AND COMPUTER READABLE MEDIUM

(71) Applicant: Toshiba Tec Kabushiki Kaisha, Tokyo (JP)

(72) Inventor: Hiroyo TANAKA, Koto Tokyo (JP)

(21) Appl. No.: 18/536,150

(22) Filed: Dec. 11, 2023

(30) Foreign Application Priority Data
Feb. 3, 2023 (JP) 2023-015244

(51) Int. Cl. G06Q 10/0639; G06Q 10/0633; G06Q 10/067

(52) U.S. Cl. CPC G06Q 10/06393; G06Q 10/0633; G06Q 10/067

(57) ABSTRACT

A management device for managing data of workflows performed by business entities, includes a memory that stores first data that represents workflows and checklists each corresponding to one of the workflows and indicating one or more items to be checked when said one of the workflows is performed, a network interface connectable to a terminal, and a processor configured to: count and store in the memory a total number of checks of each item indicated by the checklists, upon receipt of an instruction to create a new checklist corresponding to one of the workflows from the terminal, search the first data for one or more of the items that are related to said one of the workflows and have been checked at least a predetermined number of times, and generate the new checklist including the extracted items.

### CROSS-REFERENCE TO RELATED APPLICATION

This application is based upon and claims the benefit of priority from Japanese Patent Application No. 2023-015244, filed on Feb. 3, 2023, the entire contents of which are incorporated herein by reference.

### FIELD

Embodiments described herein relate generally to a management device, a management method, and a computer readable medium.

### BACKGROUND

Various work services (hereafter referred to as services) are provided at sites such as stores. In such sites, a procedure for providing a service may be designed as a workflow using a method such as a key performance indicator (KPI) tree method and business process model and notation (BPMN). In the related art, technology for making it possible to automatically create a workflow so that an input/output relationship between adjacent tasks is continuous has been proposed.

At the above-described sites, it is important to check items such as implementation requirements and effects of designed services periodically or as needed. In the related art, checklists are widely used to confirm such items are performed, but creating a checklist for each service is troublesome and difficult. Another problem is that the appropriateness of a checklist depends on the ability of a creator of the checklist.

### DESCRIPTION OF THE DRAWINGS

FIG. 1 is a diagram illustrating a configuration of a work supporting system according to an embodiment.

FIG. 2 is a hardware block diagram of a terminal device.

FIG. 3 is a hardware block diagram of a server device.

FIG. 4 is a diagram illustrating an example of a data structure of a KPI tree database (DB).

FIG. 5 is a diagram illustrating an example of a visualized KPI tree.

FIG. 6 is a diagram illustrating an example of a data structure of a workflow DB.

FIG. 7 is a diagram illustrating an example of a visualized workflow.

FIG. 8 is a diagram illustrating an example of a data structure of a checklist DB.

FIG. 9 is a diagram illustrating an example of a data structure of a customer master DB.

FIG. 10 is a functional block diagram of the terminal device and the server device.

FIG. 11 is a diagram illustrating an example of a screen provided by a checklist creation supporting unit.

FIG. 12 is a diagram illustrating an example of a screen provided by a check supporting unit.

FIG. 13 is a diagram illustrating an example of a data structure of a check result aggregate DB.

FIG. 14 is a diagram illustrating an example of a checklist generated by the checklist creation supporting unit based on aggregate information of check results.

FIG. 15 is a flowchart of processing related to creation of a checklist executed by the server device.

### DETAILED DESCRIPTION

Embodiments of the present disclosure provide a management device, a management method, and a computer readable medium for assisting in creating a new checklist.

According to one embodiment, a management device for managing data of workflows performed by business entities, comprises a memory that stores first data that represents workflows and checklists each corresponding to one of the workflows and indicating one or more items to be checked when said one of the workflows is performed; a network interface connectable to a terminal; and a processor configured to: count and store in the memory a total number of checks of each item indicated by the checklists, upon receipt of an instruction to create a new checklist corresponding to one of the workflows from the terminal, search the first data for one or more of the items that are related to said one of the workflows and have been checked at least a predetermined number of times, and generate the new checklist including the extracted items.

Hereinafter, embodiments will be described with reference to the drawings. Embodiments are not limited by the specific embodiments described below.

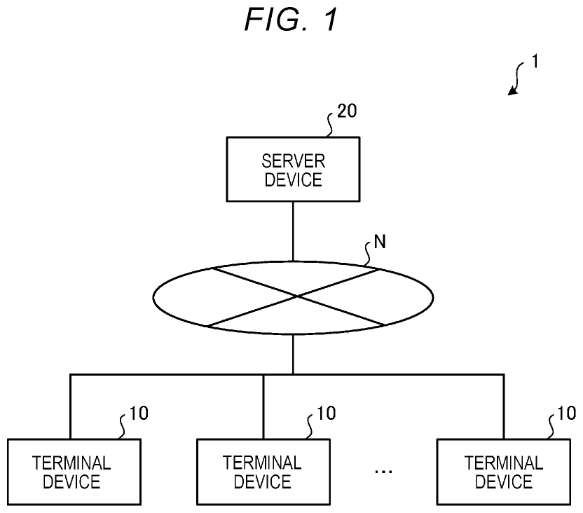

FIG. 1 is a diagram illustrating a configuration example of a work supporting system 1 according to an embodiment. As illustrated in FIG. 1, the work supporting system 1 includes a plurality of terminal devices 10 and a server device 20. The terminal devices 10 and the server device 20 are communicatively connected to each other via a network N such as a local area network (LAN).

The terminal device 10 is used by a user of the work supporting system 1. The terminal device 10 executes various processing in response to the user's operations. For example, the user uses various functions provided by the server device 20 by operating the terminal device 10 to access the server device 20. The terminal device 10 can be a stationary terminal device such as a personal computer (PC) or a portable terminal device such as a laptop PC, a tablet terminal, or a smartphone.

The server device 20 is a management device for managing workflows used by business entities such as supermarkets and drugstores. The server device 20 provides various functions to the terminal devices 10. For example, the server device 20 provides functions of creating and browsing a KPI tree, a workflow, a checklist, and the like, which will be described later.

In the present embodiment, an example in which the server device 20 is a single information processing device will be described, but embodiments of this disclosure are not limited thereto. For example, the server device 20 may include a plurality of information processing devices using technology such as cloud computing.

Next, configurations of each terminal device 10 and the server device 20 described above will be described.

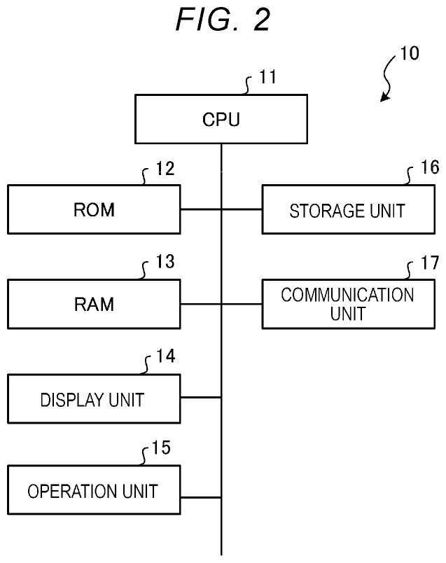

FIG. 2 is a hardware block diagram of the terminal device 10. As illustrated in FIG. 2, the terminal device 10 has a controller including a central processing unit (CPU) 11, a read only memory (ROM) 12, a random access memory (RAM) 13, and the like.

The CPU 11 is an example of a processor, and comprehensively controls each unit of the terminal device 10. The ROM 12 stores various programs. The RAM 13 is a work area for storing programs and various data.

The terminal device 10 also includes a display unit 14, an operation unit 15, a storage unit 16, and a communication unit 17.

The display unit 14 is a display device such as a liquid crystal display (LCD). The display unit 14 displays various types of information under the control of the CPU 11. The operation unit 15 includes a keyboard, a pointing device, and the like. The operation unit 15 receives an input of an operation from the user. The operation unit 15 may be a touch panel provided on a display screen of the display unit 14.

The storage unit 16 includes a storage device such as a hard disk drive (HDD) or a flash memory, and maintains stored data even if power is cut off. The storage unit 16 stores programs that can be executed by the CPU 11 and various setting information. For example, the storage unit 16 stores an application program such as a web browser that can use various functions provided by the server device 20.

The CPU 11 executes various processing by operating according to programs stored in the ROM 12 and the storage unit 16 and loaded in the RAM 13.

The communication unit 17 is a communication interface circuit that can be connected to the network N. The communication unit 17 communicates with an external device such as the server device 20 via the network N.

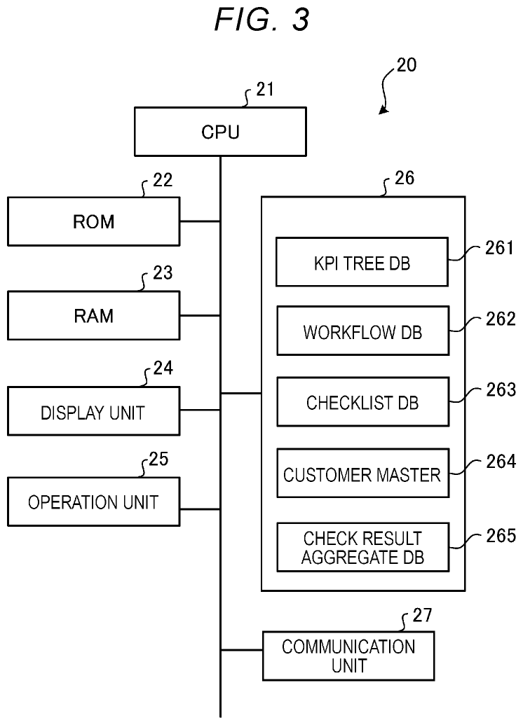

FIG. 3 is a hardware block diagram of the server device 20. As illustrated in FIG. 3, the server device 20 has a controller including a CPU 21, a ROM 22, a RAM 23, and the like.

The CPU 21 is an example of a processor, and comprehensively controls each unit of the server device 20. The ROM 22 stores various programs. The RAM 23 is a work area for storing programs and various data.

The server device 20 also includes a display unit 24, an operation unit 25, a storage unit 26, and a communication unit 27.

The display unit 24 is a display device such as an LCD. The display unit 24 displays various types of information under the control of the CPU 21. The operation unit 25 includes a keyboard, a pointing device, and the like. The operation unit 25 receives an input of an operation from the user. The operation unit 25 may be a touch panel provided on a display screen of the display unit 24.

The storage unit 26 is a storage device such as an HDD or a flash memory, and maintains stored data even if power is cut off. The storage unit 26 stores programs that can be executed by the CPU 21 and various setting information. For example, the storage unit 26 stores a web application program and the like capable of providing various functions to the terminal device 10. The CPU 21 executes various processing by operating according to programs stored in the ROM 22 and the storage unit 26 and loaded in the RAM 23.

The storage unit 26 also stores a KPI tree DB 261, a workflow DB 262, a checklist DB 263, a customer master DB 264, a check result aggregate DB 265, and the like.

The KPI tree DB 261 is a table or a database for storing and managing a KPI tree. Here, the KPI tree is a tree shape structure in which a relationship between a management target (final target, outcome, result) for an organization or a company and measures to achieve the management target (intermediate targets/goals, factors, solutions, processes, services, and the like) are set in a stepwise manner as nodes.

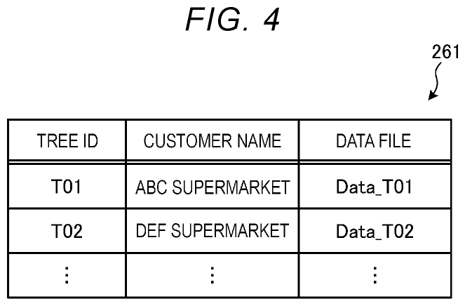

FIG. 4 is a diagram illustrating an example of a data structure of the KPI tree DB 261. As illustrated in FIG. 4, the KPI tree DB 261 stores customer names, data files for storing KPI trees, and the like in association with tree IDs by which the KPI trees can be identified.

The name of a customer to whom the KPI tree is applied is registered in the field of the customer name. The actual data of the KPI tree (hereinafter also referred to as a data file), an address indicating a storage location of the data file, or the like is registered in the field of the KPI tree.

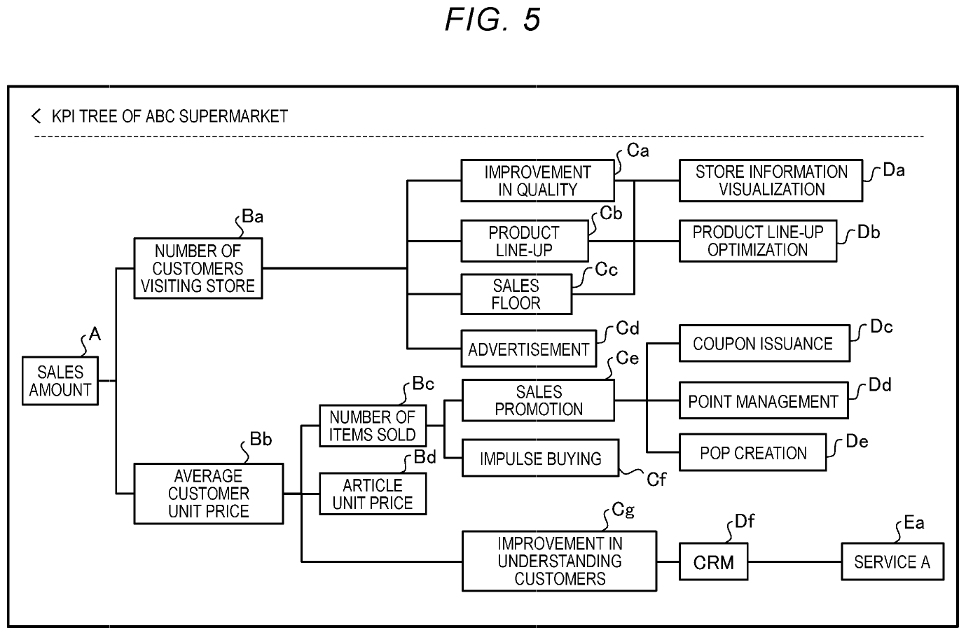

The KPI tree is created using a method including a key performance indicator (KPI). The KPI tree can be represented in a visualized state, for example, as illustrated in FIG. 5.

FIG. 5 is a diagram illustrating an example of a visualized state of a KPI tree. FIG. 5 illustrates the KPI tree applied to a customer name “ABC Supermarket” illustrated in FIG. 4.

As illustrated in FIG. 5, the KPI tree is configured by a plurality of nodes connected to have a tree structure shape. Here, a final target node A, which is also referred to as a root node, is a node for the target to be achieved. The final target node A corresponds to, for example, a key goal indicator (KGI). For example, if a final target is to increase store sales, “sales (or sales amount)” or the like is set for the final target node A.

One or more intermediate target nodes B are connected to the final target node A. One or more intermediate target nodes B can also be connected to another intermediate target node B. An intermediate target for achieving a target set for the node immediately above (final target or next intermediate target) is set for the intermediate target node B. The intermediate target nodes B correspond to, for example, key performance indicators (KPIs).

FIG. 5 illustrates an example in which an intermediate target node Ba for which an increase in the number of customers visiting the store is set and an intermediate target node Bb for which an increase in an average customer unit price is set are disposed at a subordinate position of the final target node A as intermediate targets. Further, an intermediate target node Bc for which an increase in the number of sales items is set and an intermediate target node Bd for which an increase in a unit price is set are disposed at a subordinate position of the intermediate target node Bb as intermediate targets.

In the KPI tree, a factor node C representing a factor for realizing the intermediate target set for an intermediate target node B can be disposed at a subordinate position of the intermediate target node B. The factor node C corresponds to, for example, a key success factor (KSF).

FIG. 5 illustrates an example in which factor nodes Ca to Cd for which “improvement in quality”, “product line-up”, “sales floor”, and “advertisement” are respectively set as factors for realizing an increase in the number of customers visiting the store are disposed at a subordinate position of the intermediate target node Ba. FIG. 5 also illustrates an example in which factor nodes Ce and Cf for which “sales promotion” and “impulse buying” are respectively set as factors for realizing an increase in the number of sales items are disposed at a subordinate position of the intermediate target node Bc. FIG. 5 also illustrates an example in which a factor node Cg for which “improvement in understanding customers” is set as a factor for realizing an average customer unit price is disposed at a subordinate position of the intermediate target node Bb.

In the KPI tree, a solution node D can be disposed at a subordinate position of an intermediate target node B or a factor node C, the solution node D representing a solution for realizing or solving an intermediate target or a factor that is set in a node positioned immediately above.

FIG. 5 illustrates an example in which solution nodes Da and Db for which “store information visualization” and “product line-up optimization” are respectively set are disposed at a subordinate position of the factor nodes Ca to Cc. FIG. 5 also illustrates an example in which solution nodes Dc to De for which “coupon issuance”, “point management”, and “POP creation” are respectively set are disposed at a subordinate position of the factor node Ce. FIG. 5 also illustrates an example in which a solution node Df for which “customer relationship management (CRM)” is set is disposed at a subordinate position of the factor node Cg.

In the KPI tree, a service node E can be disposed at a subordinate position of the factor node C or the solution node D, the service node E representing a specific service for realizing a factor or a solution set in a node positioned immediately above. Here, the service node E corresponds to the end measure.

Each node is assigned a node ID for identifying the node, and information on the corresponding node is stored in association with the ID. For example, the service node E is associated with a flow ID, a checklist ID, and the like, which will be described later, for designating a workflow related to the implementation of a service.

FIG. 5 illustrates an example in which a service node Ea for which “service A” is set is disposed at a subordinate position of the solution node Df.

A node ID for identifying each of nodes forming the KPI tree is given to each node. The KPI tree is stored, for example, in a JavaScript object notation (JSON) format. The data format of the KPI tree is not limited to JSON, and the KPI tree may be stored in other data formats such as extensible markup language (XML).

Referring back to FIG. 3, the workflow DB 262 is a table or a database for storing and managing workflows. A workflow is a data file in which elements related to the execution of work and execution contents executed by the elements are described as a series of procedures. Specifically, for the elements related to the implementation of the service, the execution contents executed by the elements and the procedures are described in the workflow. That is, in the present embodiment, a workflow is a concept corresponding to a service. Hereinafter, a workflow will also be referred to as a service.

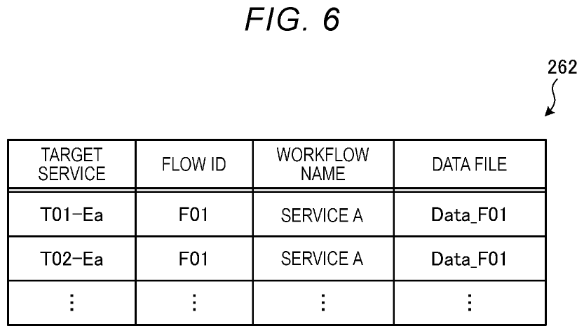

FIG. 6 is a diagram illustrating an example of a data structure of the workflow DB 262. As illustrated in FIG. 6, the workflow DB 262 stores a target service, a flow ID, a workflow name, and a data file in association with each other.

Information for designating a service corresponding to work for which a workflow is described is registered in the field of the target service. Specifically, a node ID of a service node E designated for the target service, a tree ID of a KPI tree to which the service node E belongs, and the like are registered. A method of designating the target service is not limited thereto.

A flow ID by which a workflow (process) can be identified is registered in the flow ID field. A name of the workflow is registered in the field of the workflow name. For example, the name of a service performed according to a workflow (i.e., the node name of a service node E), or the like is set for the workflow name. In the field of the data file, a data file of a workflow, an address indicating a storage location of the data file, or the like is registered.

A workflow is created using a method such as a flowchart and business process modeling notation (BPMN). The workflow is created according to a service content, but if service contents are common or similar, the same workflow can also be used even if KPI trees are different. FIG. 6 illustrates an example in which a workflow with a flow ID of “F01” is used in a service node Ea included in each of KPI trees with tree IDs of T01 and T02.

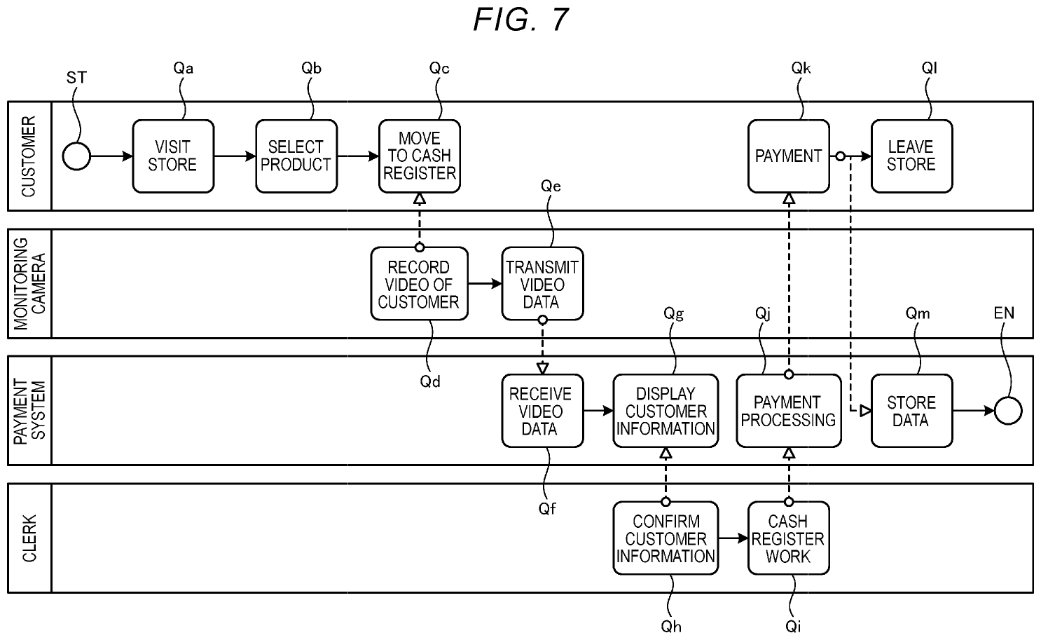

A workflow is created using techniques such as flowcharts and business process modeling notation (BPMN). A workflow can be represented in a visualized state, as illustrated in FIG. 7, for example.

FIG. 7 is a diagram illustrating an example of a visualized workflow. FIG. 7 illustrates an example of a workflow related to the service node Ea (i.e., service A) of the KPI tree illustrated in FIG. 5.

As illustrated in FIG. 7, in the workflow, a series of operation (or processing) contents related to the implementation of a service A are described for each element that performs the operation between a start event ST and an end event EN. The workflow of FIG. 7 illustrates an example in which a “customer” who visits a store, a “monitoring camera” and a “payment system” installed in the store, and a “clerk” who works at the store are described as elements.

Here, the “monitoring camera” is an example of hardware resources, and can be installed, for example, at multiple locations in the store. The “payment system” is an example of software resources, and is realized by cooperation of a plurality of computers such as POS (point of sale) terminals and applications installed in the computers. For example, a service that is additionally performed in association with payment (for example, a point service) may be included in the workflow. Hereinafter, hardware resources, software resources, and additionally performed services related to the implementation of a target service will also be collectively referred to as “elements”.

In the workflow of FIG. 7, first, as a flow of the “customer”, visiting the store (ACT Qa), selecting a product to be purchased (ACT Qb), and moving to a cash register (ACT Qc) are described. As a flow of the “monitoring camera” in the store, recording a video of the “customer” heading to the cash register (ACT Qd) and transmitting the recorded video data to the payment system provided in the store (ACT Qe) are described. As a flow of the “payment system”, receiving the video data from the “monitoring camera” (ACT Qf) and displaying customer information such as the attributes of the “customer” derived from the video data on a display device (ACT Qg) are described.

As a flow of the “clerk” who operates the cash register, confirming the customer information displayed by the “payment system” (ACT Qh) and performing cash register work for the product brought in by the “customer” (ACT Qi) are described. Executing “payment processing” by the “payment system” in association with the cash register work of the “clerk” (ACT Qj) is described.

The “customer” pays for the product according to the “payment processing” of the “payment system” (ACT Qk) and leaves the store (ACT Ql). The “payment system” stores data indicating a statement of a transaction in association with payment (ACT Qm).

If a point service is implemented, for example, the payment system combines the video data received in ACT Qf with a face image of each member which is registered in advance to specify a member number of the “customer” shown in the video data. The payment system accumulates and stores points issued according to a purchase amount in association with the specified member number.

The above-described workflow is stored, for example, in JSON format. The data format of the workflow is not limited to JSON, and the workflow may be stored in other data formats such as XML.

Referring back to FIG. 3, the checklist DB 263 is a table or a database for storing and managing checklists for checking requirements related to the implementation of a service, effects of service implementation, and the like.

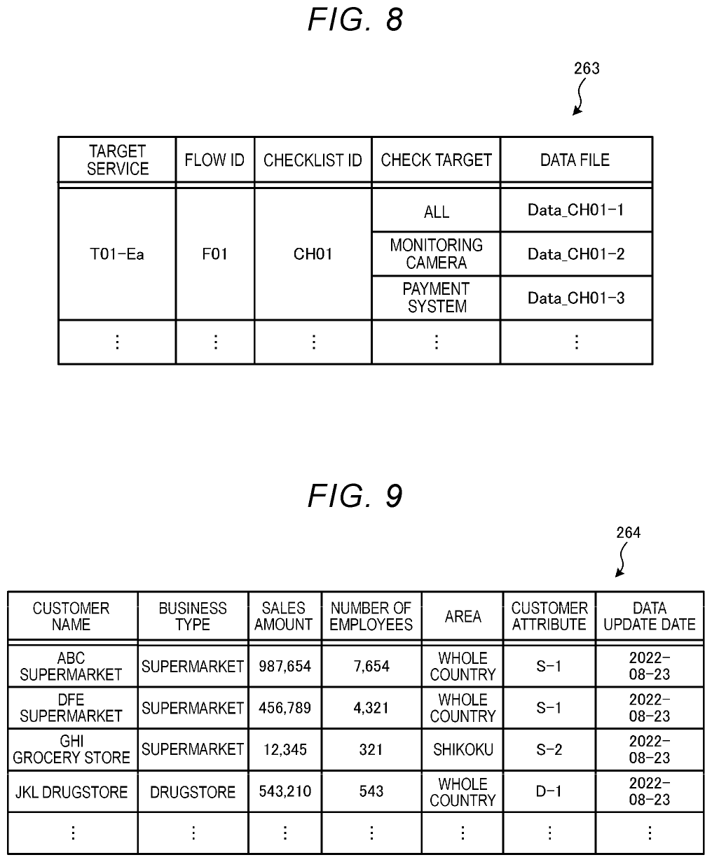

FIG. 8 is a diagram illustrating an example of a data structure of the checklist DB 263. As illustrated in FIG. 8, the checklist DB 263 stores a target service, a flow ID, a checklist ID, a check target, and a data file in association with each other.

Information for identifying a service to be checked is registered in the field of the target service. Specifically, a node ID of the service node E corresponding to the service to be checked, a tree ID of a KPI tree to which the service node E belongs, and the like are registered. In the field of the flow ID, a flow ID of a workflow corresponding to the service to be checked is registered. Although FIG. 8 illustrates an example in which both the target service and the flow ID are registered, the flow ID may be removed from the checklist DB 263 in a configuration in which the flow ID is specified from the workflow DB 262 by using the target service as a search key.

A checklist ID for identifying a checklist is registered in the field of the checklist ID. Information indicating a check target is registered in the field of the check target. For example, the names of elements such as hardware resources and software resources related to implementation of the target service are registered as check targets. For example, if the service of the service node Ea described in FIGS. 5 and 7 is set to be a target service, elements such as “monitoring camera” and “payment system” may be set to be check targets as illustrated in FIG. 8. The check target is not limited to hardware and software resources, and the entire service may be set to be a check target (corresponding to “all” in FIG. 8).

In the field of the data file, a data file of a checklist, an address indicating a storage destination of the data file, or the like is registered. The checklist is created for each check target and includes one or more check items. For example, the checklist may include check items for non-functional requirements in addition to functional requirements. Here, “non-functional requirements” indicate requirements other than functional requirements, and examples thereof include target performance, availability, security, and the like.

In the present embodiment, the KPI tree and the workflow may be created in advance, or may be created via the terminal device 10 or the like with the server device 20 performing support for creation. In the latter case, the server device 20 may provide the terminal device 10 with a screen (graphical user interface (GUI)) for supporting viewing, creation, and editing of the KPI tree and the workflow.

Specifically, the server device 20 provides the terminal device 10 with a screen on which the KPI tree can be created and edited while various nodes and relationships between the nodes are visualized. After completing the creation or editing of the KPI tree, the server device 20 stores the KPI tree in the KPI tree DB 261.

If any service node E included in the KPI tree is selected, the server device 20 provides a screen on which a workflow and a checklist can be created and edited for a service corresponding to the service node E. If either the workflow or the checklist is created, the server device 20 stores the creation result in the corresponding DB in association with a node ID and a tree ID of the service node E.

Referring back to FIG. 3, the customer master DB 264 is a table or a database for storing and managing information on the customer to whom the KPI tree is applied.

FIG. 9 is a diagram illustrating an example of a data configuration of the customer master DB 264. As illustrated in FIG. 9, the customer master DB 264 stores a business type, a sales amount, the number of employees, an area, a customer attribute, a data update date, and the like in association with a customer name. Here, the customer name corresponds to the customer name registered in the KPI tree 261 in FIG. 4.

The business type of a customer is registered in the field of the business type. For example, the type of retail business or the type of store, such as a supermarket and a drugstore, is registered as the business type. A sales amount in transactions processed by a customer is registered in the field of the sales amount. Although a period for recording a sales amount is not particularly specified, it is preferable to use the same period for recording a sales amount for all customers. The number of employees working at a customer's company or store is registered in the field of the number of employees. Information on an area in which a customer operates its business is registered in the field of the area.

Information indicating the attributes of a customer classified according to a predetermined criterion is registered in the field of the customer attribute. A criterion for classifying attributes can be set freely, and attributes can be classified based on, for example, a business type, a sales amount, the number of employees, an area, or the like. In FIG. 9, customers with a business type of “supermarket” are represented by a symbol “S”, and an example of customer attributes (S-1, S-2) divided into a plurality of levels according to the degree of a sales amount or the number of employees is shown. Customers with a business type of “drugstore” are represented by a symbol “D”, and an example of customer attributes (D-1) divided into a plurality of levels according to the degree of a sales amount or the number of employees is shown.

In the field of the data update date, the date on which data of a customer is registered in the customer master DB 264 or the date on which such data is updated is registered.

Referring back to FIG. 3, the check result aggregate DB 265 is a table or a database for storing and managing an aggregate result of checks performed using a checklist. A data structure of the check result aggregate DB 265 will be described later.

The communication unit 27 is a communication interface circuit that can be connected to the network N. The communication unit 27 communicates with an external device such as the terminal device 10 via the network N.

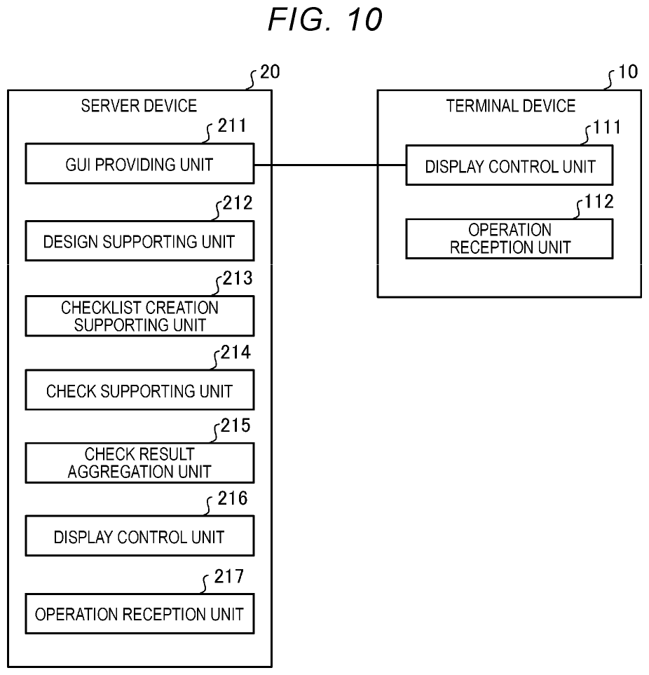

Next, functional configurations of the terminal device 10 and the server device 20 will be described with reference to FIG. 10. FIG. 10 is a functional block diagram of the terminal device 10 and the server device 20.

As illustrated in FIG. 10, the terminal device 10 includes a display control unit 111 and an operation reception unit 112 as functional units.

Some or all of the functional units provided in the terminal device 10 may be performed by a processor (for example, the CPU 11) of the terminal device 10 according to programs stored in the memory (for example, the ROM 12, the storage unit 16). Some or all of the functional units provided in the terminal device 10 may be performed by hardware such as a dedicated circuit and the like mounted in the terminal device 10.

The display control unit 111 of the terminal device 10 controls the display unit 14 to display various screens on the display unit 14. For example, the display control unit 111 causes the display unit 14 to display various operation screens based on information provided from the server device 20.

The operation reception unit 112 of the terminal device 10 receives user operations via the operation unit 15. For example, if an operation on a screen displayed on the display unit 14 is received, the operation reception unit 112 notifies the server device 20 of the operation content.

On the other hand, the server device 20 includes a GUI providing unit 211, a design supporting unit 212, a checklist creation supporting unit 213, a check supporting unit 214, a check result aggregation unit 215, a display control unit 216, and an operation reception unit 217 as functional units.

Some or all of the functional units provided in the server device 20 may 20 may be implemented or performed by a processor (for example, the CPU 21) of the server device 20 according to programs stored in the memory (for example, the ROM 22, the storage unit 26). Some or all of the functional units provided in the server device 20 may be implemented or performed by a dedicated circuit and the like mounted in the server device 20.

The GUI providing unit 211 provides the terminal device 10 with information by which various operation screens (hereinafter also simply referred to as screens) can be displayed in cooperation with other functional units. Here, the GUI providing unit 211 may generate and output data representing a screen, or may generate and output various content data related to the display of the screen. Hereinafter, the GUI providing unit 211 providing the terminal device 10 with information on the display of a screen will also be referred to as “providing” the screen or “displaying” the screen.

The design supporting unit 212 provides a screen for supporting the creation of a KPI tree and a workflow in cooperation with the GUI providing unit 211.

For example, the design supporting unit 212 provides a screen on which a KPI tree can be created and various nodes, edges, and the like are disposed as drawing parts. Here, the design supporting unit 212 outputs a visualized KPI tree in response to a user's operation. The design supporting unit 212 can associate a workflow (or flow ID) with the service node E of the KPI tree in response to the user's operation. If the design supporting unit 212 detects an operation to complete the creation or editing of the KPI tree, the design supporting unit 212 generates a data file representing the KPI tree and stores the generated data file in the KPI tree DB 261.

The design supporting unit 212 provides a screen on which a KPI tree to be browsed or edited can be selected, based on the KPI tree DB 261. If the KPI tree is selected, the design supporting unit 212 reads the KPI tree from the KPI tree DB 261 and provides a screen on which the KPI tree is visualized.

The design supporting unit 212 provides a screen on which a workflow can be created, and drawing parts and the like corresponding to BPMN notation rules are disposed. Here, the design supporting unit 212 outputs the visualized workflow in response to the user's operation. If the design supporting unit 212 detects an operation to complete the creation or editing of the workflow, the design supporting unit 212 generates a data file representing the workflow and stores the generated data file in the workflow DB 262 in association with a target service.

The checklist creation supporting unit 213 provides a screen for supporting the creation of a checklist in cooperation with the GUI providing unit 211. Specifically, if the checklist creation supporting unit 213 detects an instruction to create a checklist designating a service to be checked via a KPI tree or the like, the checklist creation supporting unit 213 provides a screen for supporting the creation of the checklist.

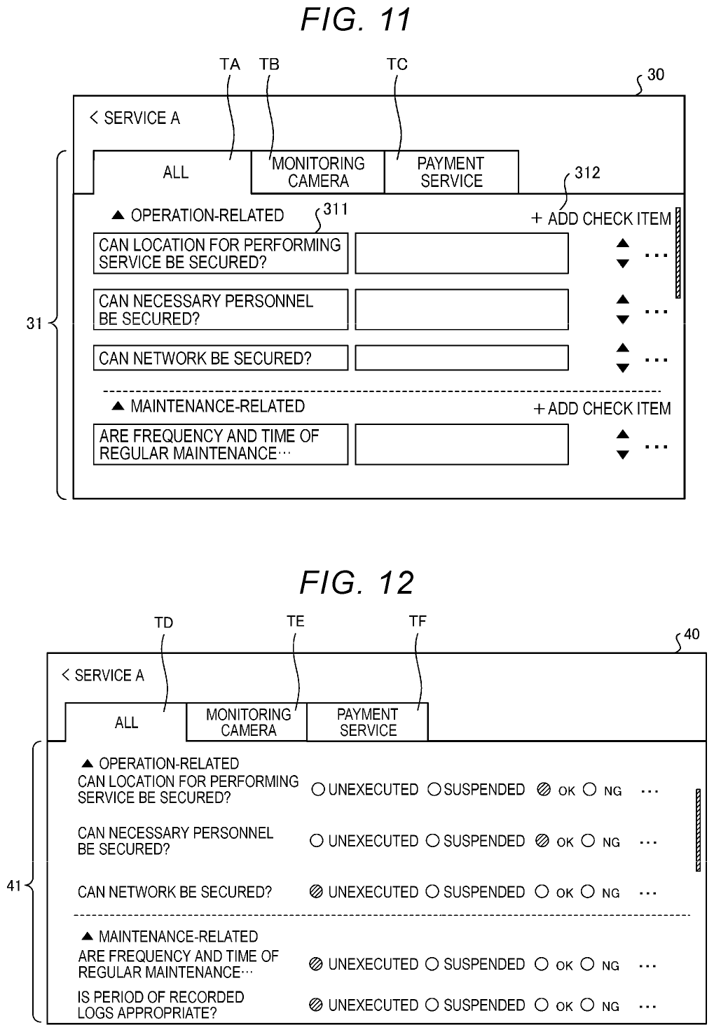

Here, FIG. 11 is a diagram illustrating an example of a screen provided by the checklist creation supporting unit 213 (hereinafter also referred to as a creation supporting screen). FIG. 11 illustrates a creation supporting screen if the service node Ea included in the KPI tree of FIG. 5 is selected.

As illustrated in FIG. 11, the creation supporting screen 30 includes a tab TA corresponding to “all”, a tab TB corresponding to “monitoring camera”, and a tab TC corresponding to “payment service”. The tabs TA to TC are provided for each check target. The tabs may be automatically generated based on elements and the like included in a workflow of a designated service, or may be added or deleted in response to the user's operation.

Here, if any one of the tabs TA to TC is selected, the checklist creation supporting unit 213 provides a screen on which a checklist corresponding to the selected tab can be edited on an input region 31. FIG. 11 illustrates an example in which the tab TA corresponding to “all” is selected.

The input region 31 is provided with an input field 311 in which check items can be input. Any character string can be input in the input field 311. The user sets check items by inputting character strings representing items to be checked in the input field 311. The user can also edit the character strings displayed in the input field 311. The input field 311 can also be added by operating an add button 312.

For example, the check items are provided separately for each common group. FIG. 11 illustrates an example in which check items are divided into an operation-related group and a maintenance-related group. In the input region 31, the user can freely set and edit groups.

If the checklist creation supporting unit 213 detects an operation that instructs to complete editing, the checklist creation supporting unit 213 generates a checklist (i.e., data file) for each check target based on the check items set in the input region 31. Then, the checklist creation supporting unit 213 stores the generated checklist in the checklist DB 263 in association with a target service and a flow ID.

The checklist creation supporting unit 213 has a function of automatically generating a checklist based on information stored in the check result aggregate DB 265. The function related to automatic generation of the checklist will be described later.

Referring back to FIG. 10, the check supporting unit 214 provides a screen for supporting check work using a checklist in cooperation with the GUI providing unit 211.

If the checklist creation supporting unit 213 detects an instruction for performing check work of designating a target service to be checked via a KPI tree or the like, the checklist creation supporting unit 213 provides a screen for supporting the check work. Specifically, the check supporting unit 214 reads a checklist associated with the target service from the checklist DB 263. Then, the check supporting unit 214 provides a screen for supporting the check work based on the read checklist.

FIG. 12 is a diagram illustrating an example of a screen provided by the check supporting unit 214 (hereinafter also referred to as a check screen). Here, FIG. 12 illustrates a check screen for a checklist generated by the creation supporting screen in FIG. 11. As illustrated in FIG. 12, a check screen 40 includes tabs TD to TF corresponding to the tabs TA to TC illustrated in FIG. 11 and makes it possible to switch a check target by an operation of selecting the tabs.

Specifically, the check supporting unit 214 generates a tab for each check target, and generates a check screen on which the check target can be switched using the tab. On a screen displayed by a tab switching operation, a checklist to be checked which corresponds to the tab is displayed. In other words, it is possible to switch a checklist by switching the tab.

FIG. 12 illustrates a state in which the tab TD corresponding to “all” is selected, and check items of each of an operation-related group and a maintenance-related group, which are set in the checklist of “all”, are displayed in an input region 41. Each of the check items is associated with four options of “unexecuted”, “suspended”, “OK”, and “NG”, and any one of the options can be selected.

Thereby, the user can select corresponding options while confirming the contents of check items for the check targets selected on the tabs TD to TF. Thus, the user can easily confirm the check items related to the implementation of a service. Here, the user who performs the check can freely select an option for each of the check items. The selection of an option is not essential, and for example, for a check item for which it is determined that a check is unnecessary, the next check item can be checked without selecting any option.

Although four options are provided for a check item in FIG. 12, the number and types of options are not limited thereto. For example, a configuration in which a character string can be input as a response to a check item may be adopted. A configuration in which a method of responding to a check item can be set at the stage of creating a checklist may be adopted.

If the check supporting unit 214 detects an operation instructing to complete a check, the check supporting unit 214 stores a result of a check performed on each check item in association with the corresponding checklist to be checked.

Here, it is assumed that a storage location of the check result is not particularly specified. For example, the check supporting unit 214 may store the check result in the checklist DB 263 in direct association with the corresponding checklist (i.e., data file) of the checklist DB 263. The check supporting unit 214 may store check results in a storage unit (a database or the like) different from the checklist DB 263. The check supporting unit 214 performs generation management and the like by associating the date on which a check is performed with a check result to store check results of each time so that each check result can be referred to.

Referring back to FIG. 10, the check result aggregation unit 215 aggregates the number of service checks performed using a checklist for each check item, and stores the aggregate result in the check result aggregate DB 265. Specifically, the check result aggregation unit 215 aggregates the number of checks performed on each check item of a checklist for each service or workflow to be checked, and for each customer attribute of a customer related to a KPI tree to which the service belongs. Then, the check result aggregation unit 215 stores the number of checks for each check item in the check result aggregate DB 265 as an aggregate result.

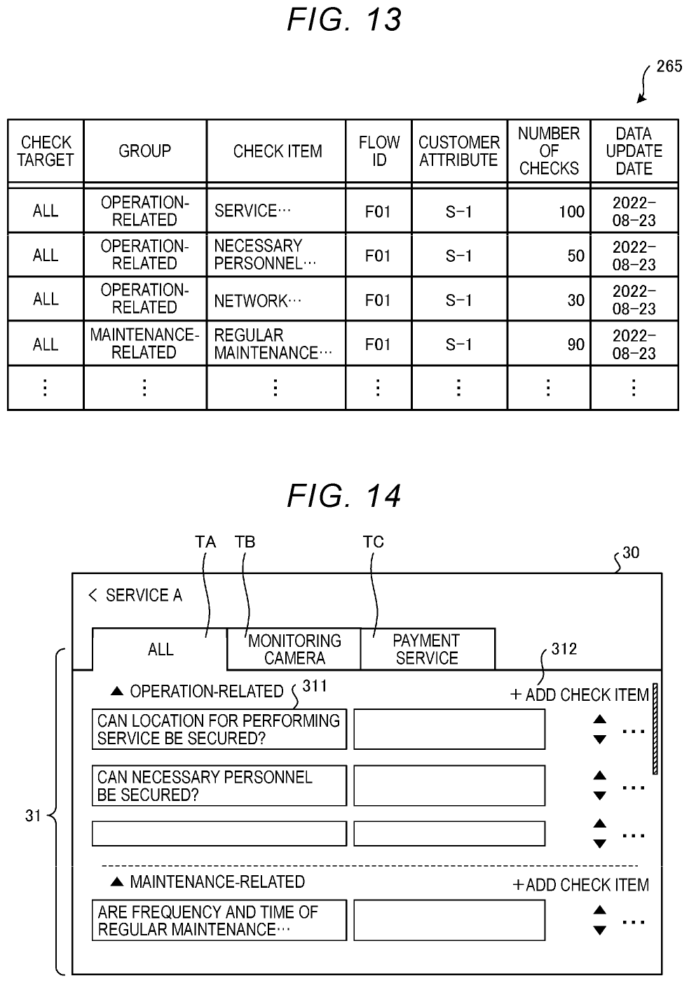

FIG. 13 is a diagram illustrating an example of a data structure of the check result aggregate DB 265. As illustrated in FIG. 13, the check result aggregate DB 265 stores a check target, a group, a check item, a flow ID, a customer attribute, the number of checks, a data update date, and the like in association with each other.

In the field of the check target, a check target of a checklist to be aggregated is registered. In the field of the group, a group name or the like of a group included in a checklist to be aggregated is registered. In the field of the check item, a check item included in a group to be aggregated is registered. In the field of the flow ID, a flow ID associated with a checklist ID of a checklist to be aggregated, that is, a flow ID of a service to be checked is registered. In the field of the customer attribute, a customer attribute of a customer related to a KPI tree that includes a service to be checked is registered.

In the field of the number of checks, the number of checks performed on a check item is registered. Specifically, the check result aggregation unit 215 aggregates the number of checks performed on each of check items included in a checklist which have the same flow ID for each customer attribute related to the checklist, and registers the number of checks as the number of checks of the corresponding data entry.

Here, the check result aggregation unit 215 counts the selection of any option of a check item as one time, and counts a case where no option is selected as zero. A method of counting the number of checks is not limited thereto, and can also be set freely. For example, the number of times a specific option is selected from among options of a check item may be counted.

The date on which the number of checks is updated is registered in the field of the data update date. The check result aggregation unit 215 updates the data update date to the current date at a timing when the number of checks is registered or updated.

As such, check results are aggregated in units of checklists to be checked, groups, and check items. The check results are aggregated in units of flow IDs and customer attributes. Therefore, for example, if the services that are set in KPI trees that differ from each other and have common customer attributes are checked using checklists having similar contents, the check results are aggregated in the same aggregation group. On the other hand, if the customer attributes of customers to whom the KPI tree is applied are different from each other, the check results are aggregated in different aggregation groups for each customer attribute.

For example, depending on a customer to whom the KPI tree is applied, there is a possibility that the wording of check items set in a checklist may be different even if the contents of check items mean the same contents. Here, it is preferable that the check result aggregation unit 215 merge check items with similar contents and aggregate check results by using a known natural language processing technique or the like. For example, if the content of a character string of a check item means confirming the securing of a network, the check result aggregation unit 215 merges the check results into one representative check item and aggregates the number of checks even if there is a difference in notation.

The data configuration of the check result aggregate DB 265 is not limited to that illustrated in FIG. 13, and may include, for example, other items. Specifically, the check result aggregate DB 265 may include an operation period of a service corresponding to a workflow of a flow ID as an item. Here, for example, the check result aggregation unit 215 divides and aggregates the number of checks for each predetermined period (e.g., monthly basis and the like) based on an operation period at a timing when a check is performed.

Incidentally, if the contents of services performed by a plurality of customers are the same, that is, if workflows are the same, it is highly likely that check items to be checked in a checklist will also be the same. Consequently, if the creation of a new checklist is instructed for a service similar to a workflow to be checked by an existing checklist, the checklist creation supporting unit 213 generates a checklist in which check items are automatically set, based on a data entry stored in the check result aggregate DB 265 (hereinafter also referred to as aggregate information).

Specifically, if the checklist creation supporting unit 213 is instructed to create a new checklist designating a service to be checked via a KPI tree or the like, a flow ID of a workflow related to the service to be checked and a customer attribute of a customer are used as search keys, and aggregate information corresponding to the search keys is searched for from the check result aggregate DB 265. Here, if there is aggregate information corresponding to the search keys, the checklist creation supporting unit 213 extracts aggregate information in which the number of checks is equal to or greater than a threshold value, based on the number of checks included in the searched aggregate information. Then, the checklist creation supporting unit 213 generates a checklist in which check items are set for each check target, based on the check targets, groups, and check items included in the extracted aggregate information.

If there is no aggregate information corresponding to the search keys, the checklist creation supporting unit 213 provides a creation supporting screen for the user to set check items from scratch, as described above.

Here, it is assumed that a new checklist is created for a service with a flow ID of “F01” in a KPI tree created for a customer with a customer attribute of “S-1”. Here, the checklist creation supporting unit 213 searches for four data entries respectively having the numbers of checks of 100, 50, 30, and 90 as aggregate information corresponding to the conditions of the customer attribute “S-1” and the flow ID “F01” from the check result aggregate DB 265 illustrated in FIG. 13. Here, assuming that a threshold value for the number of checks is 50 or more, the checklist creation supporting unit 213 extracts three data entries respectively having the numbers of checks of 100, 50, and 90. Then, the checklist creation supporting unit 213 generates a checklist in which check items are set based on the check targets, groups, and check items included in the extracted data entries, and displays a screen showing the checklist.

FIG. 14 is a diagram illustrating an example of a checklist generated by the checklist creation supporting unit 213 based on check result aggregate information. A screen in FIG. 14 is a creation supporting screen that is the same as that in FIG. 11, and check items related to a check item “all” are displayed in the input region 31.

Here, in the creation supporting screen illustrated in FIG. 14, character strings representing confirmation items are set in check items and displayed in the input region 31 for an operation-related group and a maintenance-related group. A check item “Can a network be secured?” for which the number of checks is less than a threshold value is removed from the input region 31.

As such, if the checklist creation supporting unit 213 is instructed to create a checklist, the checklist creation supporting unit 213 automatically generates a checklist in which check items are set, based on check aggregated results for existing checklists that have common customer attributes and contents of a service to be checked. Thereby, the checklist creation supporting unit 213 can generate a checklist including check items that are effectively utilized during a check, and thus it is possible to save the user's time and effort for creating the checklist from scratch.

Since the checklist creation supporting unit 213 can generate a checklist excluding check items that are rarely used, it is possible to generate a checklist including essential check items. Thus, the checklist creation supporting unit 213 can generate a highly appropriate checklist that does not depend on the ability of a creator of the checklist.

Since the checklist creation supporting unit 213 extracts check items by narrowing down the check items to aggregate information that has common services or flow IDs and customer attributes, it is possible to generate a checklist including check items having similar viewpoints of a check such as a scale for performing a service and a target for the service.

In the above-described example, check items are extracted based on the number of checks, but extraction conditions are not limited to the number of checks. For example, a data update date may be added to the extraction conditions to extract aggregate information in which a data update date is included in a predetermined period. Here, the predetermined period can be set to be, for example, within one month or half a year from the current date. Thereby, the checklist creation supporting unit 213 can generate a checklist based on the latest aggregate results.

If the check result aggregate DB 265 includes a service operation period as a field, that field may be added to the extraction conditions. For example, if the service operation period is added to the extraction conditions, the checklist creation supporting unit 213 may extract aggregate information of a category to which the operation period belongs, based on an operation time of a service for which a checklist is created. Thereby, for example, check items that are frequently checked during a specific period, such as at the start of a service, can be included in or excluded from extraction targets. Thus, it is possible to efficiently extract check items suitable for the actual situation of the service for which the checklist is created.

In the screen illustrated in FIG. 14, it is assumed that the user can edit the check items automatically set by the checklist creation supporting unit 213. However, embodiments of this disclosure are not limited thereto, and a configuration in which editing operations for check items automatically set by the checklist creation supporting unit 213 are disabled may be adopted.

In the present embodiment, the checklist creation supporting unit 213 is configured to generate a checklist from which check items for which the number of checks is less than a threshold value are removed, but embodiments of this disclosure are not limited thereto. For example, the checklist creation supporting unit 213 may generate a checklist in which check items for which the number of checks is less than the threshold value are represented in an identifiable state. Here, the checklist creation supporting unit 213 may represent check items for which the number of checks is less than the threshold value in red, so that the check items can be identified from other check items.

In the present embodiment, the checklist creation supporting unit 213 is configured to control the screen to display the generated checklist in an editable state, but embodiments of this disclosure are not limited thereto. For example, the checklist creation supporting unit 213 may immediately store the generated checklist in the checklist DB 263. The checklist creation supporting unit 213 may immediately generate a check screen for display based on the generated checklist in cooperation with the check supporting unit 214.

Referring back to FIG. 10, the display control unit 216 of the server device 20 controls the display unit 24 to display various screens on the display unit 24. For example, the display control unit 216 causes the display unit 24 to display various screens provided by the GUI providing unit 211.

The operation reception unit 217 of the server device 20 detects user operations via the operation unit 25. For example, if the operation reception unit 217 detects an operation on various operation support screens displayed on the display unit 24, the operation reception unit 217 recognizes the operation content.

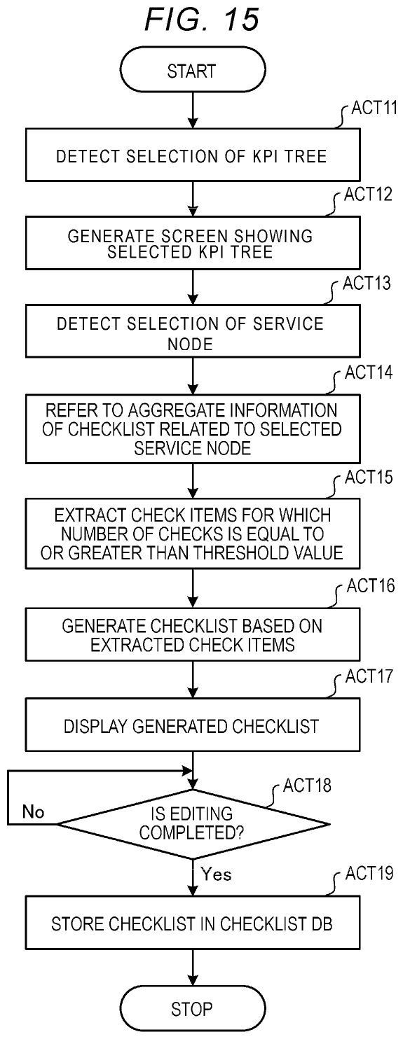

Hereinafter, an operation example of the server device 20 described above will be described. FIG. 15 is a flowchart of processing related to the generation of a checklist and executed by the server device 20. As a premise of the processing, it is assumed that existing checklists are stored in the checklist DB 263, and aggregate information on results of checks performed using the checklists is stored in the check result aggregate DB 265.

First, the design supporting unit 212 detects selection of a KPI tree to be displayed from among the KPI trees registered in the KPI tree DB 261 (ACT 11). Next, the design supporting unit 212 generates a screen showing the selected KPI tree for display (ACT 12).

Subsequently, the checklist creation supporting unit 213 detects selection of the service node E for which a checklist is to be created from the displayed KPI tree (ACT 13). If the service node E is selected, the checklist creation supporting unit 213 refers to aggregate information of the checklist related to the service node E and stored in the check result aggregate DB (ACT 14). More specifically, the checklist creation supporting unit 213 searches for aggregate information corresponding to conditions of a customer attribute of a customer related to the KPI tree selected in ACT 11 and a flow ID of a workflow related to the service node E selected in ACT 13 from the check result aggregate DB.

Subsequently, the checklist creation supporting unit 213 extracts check items for which the number of checks is equal to or greater than a threshold value from the aggregate information based on the number of checks of the searched aggregate information (ACT 15). Next, the checklist creation supporting unit 213 generates a checklist based on the extracted check items (ACT 16) and displays a screen on which the checklist can be edited (ACT 17).

Here, a user who operates the screen can edit or add check items as described in FIG. 11. If the user finishes the editing operation, the user instructs to complete editing. The editing operation is not essential, and the user may instruct to complete editing without performing the editing operation.

The checklist creation supporting unit 213 waits until the completion of editing is instructed (ACT 18; No). If the checklist creation supporting unit 213 detects the instruction to complete editing (ACT 18; Yes), the checklist creation supporting unit 213 stores the checklist displayed on the screen in the checklist DB 263 (ACT 19), and finishes the processing.

As described above, the server device 20 of the present embodiment aggregates the number of checks of services related to a workflow checked using a checklist for each type of workflow and each check item included in the checklist. If the server device 20 receives an instruction to create a new checklist designating a service to be checked, the server device 20 extracts check items for which the number of checks is equal to or greater than a threshold value from aggregate results related to a service to be checked, and generates a new checklist based on the extracted check items.

As such, if the server device 20 is instructed to create a new checklist, the server device 20 generates a checklist using effectively used check items among the check items included in the checklist used for services having the same check target. Thereby, the server device 20 can save the user's time and effort for creating a checklist from scratch, and thus it is possible to support the creation of the checklist. Since the server device 20 can generate a checklist from which check items that are rarely used are omitted, it is possible to generate a checklist including essential check items. Thus, the server device 20 can generate a highly appropriate checklist that does not depend on the ability of a creator of the checklist.

The server device 20 aggregates the number of checks for each customer attribute of a customer who performs a service, and extracts check items for which the number of checks is equal to or greater than a threshold value from aggregate results related to a customer attribute of a customer who performs a service to be checked of a newly created checklist. Thereby, the server device 20 can include check items in the checklist from a viewpoint of a check suitable for the attribute of the customer who performs the service, and thus it is possible to generate a highly appropriate checklist.

The server device 20 can also separately aggregate the number of checks for check items for each predetermined period based on an operation period of a service. Here, the server device 20 extracts check items for which the number of checks is equal to or greater than a threshold value from aggregate results of a category to which an operation period of a service to be checked of a newly created checklist belongs. Thereby, the server device 20 can include check items that are frequently checked in the checklist during the operation period of the service to be checked, and thus it is possible to generate a highly appropriate checklist.

The server device 20 provides a screen on which the generated checklist can be edited, and reflects the result of editing performed through the screen on the generated checklist. Thereby, the server device 20 can reflect the user's intention in the generated checklist, and thus it is possible to support the creation of the checklist.

The server device 20 receives an instruction to create a checklist by selecting the service node E set in the KPI tree. Thereby, the server device 20 can receive the instruction to create the checklist based on the KPI tree, and thus it is possible to improve the user's convenience related to work support.

The above-described embodiment can also be appropriately modified and implemented by changing some of the configurations or functions of the devices described above. Consequently, hereinafter, some modification examples will be described as other embodiments. Points different from the above-described embodiment will be mainly described, and additional description of points common to those already described will be omitted. The modification examples to be described below may be implemented individually or in combination with each other as appropriate.

### MODIFICATION EXAMPLE 1

In the above-described embodiment, an example in which various screens provided by the server device 20 are displayed on the terminal device 10 by cooperation of the terminal device 10 and the server device 20 is described. However, embodiments of this disclosure are not limited thereto, and a configuration in which the terminal device 10 displays the screens independently may be adopted.

Here, the terminal device 10 can display various screens related to the creation and editing of a checklist by including functional units such as the GUI providing unit 211, the design supporting unit 212, the checklist creation supporting unit 213, and the check supporting unit 214 described above. It is assumed that the terminal device 10 is capable of reading and writing various DBs stored in the server device 20.

Here, some or all of the KPI tree DB 261, the workflow DB 262, the checklist DB 263, the customer master DB 264, and the check result aggregate DB 265 may be stored in the terminal device 10, or may be stored in another device or cloud that can be accessed by the terminal device 10.

### MODIFICATION EXAMPLE 2

In the above-described embodiment, the server device 20 is configured to store and manage a workflow in association with the service node E of a KPI tree. However, embodiments of this disclosure are not limited thereto, and a configuration may be adopted in which the server device 20 stores and manages a workflow independently without associating the workflow with the service node E.

### MODIFICATION EXAMPLE 3

In the above-described embodiment, a configuration in which check results are aggregated for each customer attribute is adopted. However, embodiments of this disclosure are not limited thereto, and check results may be aggregated without using a customer attribute. Instead of the customer attribute, check results may be aggregated for each detail such as a customer name, a business type, or an area of a customer. Here, it is assumed that the checklist creation supporting unit 213 extracts check items using aggregate information corresponding to details such as a customer name, a business type, and an area, which are related to a service designated by an instruction to create a checklist.

The programs executed by the devices in the above-described embodiments can be provided as programs installed in the ROM, the storage unit, or the like in advance. A configuration may be adopted in which the programs executed by the devices may be provided by being recorded in a non-transitory, computer readable recording medium such as a CD-ROM, a flexible disk (FD), CD-R, a digital versatile disk (DVD) as a file in an installable format or an executable format.

A configuration may be adopted in which the programs executed by the devices are stored on a computer connected to a network such as the Internet and downloaded via the network. A configuration may be adopted in which the programs executed by the devices in are accessed or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management device for managing data of workflows performed by business entities, the device comprising:
a memory that stores first data that represents workflows and checklists each corresponding to one of the workflows and indicating one or more items to be checked when said one of the workflows is performed;
a network interface connectable to a terminal; and
a processor configured to:
count and store in the memory a total number of checks of each item indicated by the checklists,
upon receipt of an instruction to create a new checklist corresponding to one of the workflows from the terminal, search the first data for one or more of the items that are related to said one of the workflows and have been checked at least a predetermined number of times, and
generate the new checklist including the extracted items.

2. The management device according to claim 1, wherein the processor is configured to:
count and store in the memory the total number of checks of each item indicated by the checklists for each attribute of the business entities,
upon receipt of an instruction to create a new checklist corresponding to one of the workflows from one of the business entities, search the first data for one or more of the items that are related to said one of the workflows and an attribute of said one of the business entities and that have been checked at least the predetermined number of times, and
generate the new checklist including the extracted items and update the first data to include the generated new checklist.

3. The management device according to claim 1, wherein the processor is configured to:
count and store in the memory the total number of checks of each item indicated by the checklists in association with time periods of a day in which the checks are performed,
upon receipt of an instruction to create a new checklist corresponding to one of the workflows from the terminal, extract one or more of the items that are related to said one of the workflows and have been checked at least the predetermined number of times in a time period of a day in which said one of the workflows is performed, and
generate the new checklist including the extracted items and update the first data to include the generated new checklist.

4. The management device according to claim 1, wherein the processor is configured to cause, through the network interface, the terminal to display a screen indicating the new checklist in an editable manner.

5. The management device according to claim 1, wherein
the memory stores second data that represents key performance indicator (KPI) trees in which a relationship between a management target and measures to achieve the target is defined using nodes connected to each other, and
an end node of each KPI tree corresponds to one of the workflows represented by the first data.

6. The management device according to claim 5, wherein the processor is configured to cause, through the network interface, the terminal to display a screen showing an entire structure of one of the KPI trees and through which the instruction to create a new checklist can be issued when the end node of said one of the KPI trees is selected.

7. The management device according to claim 5, wherein another end node of each KPI tree corresponds to the management target.

8. A management method for managing data of workflows performed by business entities, the method comprising:
storing in a memory first data that represents workflows and checklists each corresponding to one of the workflows and indicating one or more items to be checked when said one of the workflows is performed;
counting and storing in the memory a total number of checks of each item indicated by the checklists;
upon receipt of an instruction to create a new checklist corresponding to one of the workflows from a terminal, searching the first data for one or more of the items that are related to said one of the workflows and have been checked at least a predetermined number of times; and
generating the new checklist including the extracted items.

9. The management method according to claim 8, further comprising:
counting and storing in the memory the total number of checks of each item indicated by the checklists for each attribute of the business entities;
upon receipt of an instruction to create a new checklist corresponding to one of the workflows from one of the business entities, searching the first data for one or more of the items that are related to said one of the workflows and an attribute of said one of the business entities and that have been checked at least the predetermined number of times; and
generating the new checklist including the extracted items and updating the first data to include the generated new checklist.

10. The management method according to claim 8, further comprising:
counting and storing in the memory the total number of checks of each item indicated by the checklists in association with time periods of a day in which the checks are performed;
upon receipt of an instruction to create a new checklist corresponding to one of the workflows from the terminal, searching the first data for one or more of the items that are related to said one of the workflows and have been checked at least the predetermined number of times in a time period of a day in which said one of the workflows is performed; and
generating the new checklist including the extracted items and updating the first data to include the generated new checklist.

11. The management method according to claim 8, further comprising:
causing the terminal to display a screen indicating the new checklist in an editable manner.

12. The management method according to claim 8, further comprising:
storing second data that represents key performance indicator (KPI) trees in which a relationship between a management target and measures to achieve the target is defined using nodes connected to each other, wherein
an end node of each KPI tree corresponds to one of the workflows represented by the first data.

13. The management method according to claim 12, further comprising:
causing the terminal to display a screen showing an entire structure of one of the KPI trees and through which the instruction to create a new checklist can be issued when the end node of said one of the KPI trees is selected.

14. The management method according to claim 12, wherein another end node of each KPI tree corresponds to the management target.

15. A non-transitory computer readable medium storing a program causing a computer to execute a management method for managing data of workflows performed by business entities, the method comprising:
storing in a memory first data that represents workflows and checklists each corresponding to one of the workflows and indicating one or more items to be checked when said one of the workflows is performed;
counting and storing in the memory a total number of checks of each item indicated by the checklists;
upon receipt of an instruction to create a new checklist corresponding to one of the workflows from a terminal, searching the first data for one or more of the items that are related to said one of the workflows and have been checked at least a predetermined number of times; and
generating the new checklist including the extracted items.

16. The computer readable medium according to claim 15, wherein the method further comprises:
counting and storing in the memory the total number of checks of each item indicated by the checklists for each attribute of the business entities;
upon receipt of an instruction to create a new checklist corresponding to one of the workflows from one of the business entities, searching the first data for one or more of the items that are related to said one of the workflows and an attribute of said one of the business entities and that have been checked at least the predetermined number of times; and
generating the new checklist including the extracted items and updating the first data to include the generated new checklist.

17. The computer readable medium according to claim 15, wherein the method further comprises:
counting and storing in the memory the total number of checks of each item indicated by the checklists in association with time periods of a day in which the checks are performed;
upon receipt of an instruction to create a new checklist corresponding to one of the workflows from the terminal, searching the first data for one or more of the items that are related to said one of the workflows and have been checked at least the predetermined number of times in a time period of a day in which said one of the workflows is performed; and
generating the new checklist including the extracted items and updating the first data to include the generated new checklist.

18. The computer readable medium according to claim 15, wherein the method further comprises:
causing the terminal to display a screen indicating the new checklist in an editable manner.

19. The computer readable medium according to claim 15, wherein the method further comprises:
storing second data that represents key performance indicator (KPI) trees in which a relationship between a management target and measures to achieve the target is defined using nodes connected to each other, wherein
an end node of each KPI tree corresponds to one of the workflows represented by the first data.

20. The computer readable medium according to claim 19, wherein the method further comprises:
causing the terminal to display a screen showing an entire structure of one of the KPI trees and through which the instruction to create a new checklist can be issued when the end node of said one of the KPI trees is selected.
